(19) United States
(12) Patent Application Publication
(10) Pub. No.: US 2024/0232794 A9
(43) Pub. Date: Jul. 11, 2024

(54) DETERMINING HEALTH-RELATED INFORMATION OF RETURNED INVENTORY USING ARTIFICIAL INTELLIGENCE TECHNIQUES

(71) Applicant: Dell Products L.P., Round Rock, TX (US)

(72) Inventors: Parminder Singh Sethi, Punjab (IN); Manish Gupta, Delhi (IN); Praveen Kumar, Uttar Pradesh (IN)

(21) Appl. No.: 17/971,088

(22) Filed: Oct. 21, 2022

(51) Int. Cl. G06Q 10/08

(52) U.S. Cl. CPC G06Q 10/087

(57) ABSTRACT

Methods, apparatus, and processor-readable storage media for determining health-related information of returned inventory using artificial intelligence techniques are provided herein. An example computer-implemented method includes determining current state-related information pertaining to at least one returned inventory item; determining health-related information of the at least one returned inventory item by processing, using one or more artificial intelligence techniques, at least a portion of the current state-related information and historical inventory-related data associated with one or more additional inventory items; and performing one or more automated actions in connection with the at least one returned inventory item based at least in part on at least a portion of the determined health-related information.

### FIELD

The field relates generally to information processing systems, and more particularly to techniques for data processing using such systems.

### BACKGROUND

Enterprises commonly refurbish returned inventory and resell the refurbished inventory in the market via various channels. However, conventional refurbishment techniques typically attempt to simply address user-stated inventory issues and resell the inventory without insights into the remaining lifespan of the inventory, often resulting in resource wastage, detrimental environmental impacts, and user dissatisfaction.

### SUMMARY

Illustrative embodiments of the disclosure provide techniques for automatically determining health-related data associated with returned inventory using artificial intelligence techniques.

An exemplary computer-implemented method includes determining current state-related information pertaining to at least one returned inventory item, and determining health-related information of the at least one returned inventory item by processing, using one or more artificial intelligence techniques, at least a portion of the current state-related information and historical inventory-related data associated with one or more additional inventory items. Additionally, the method includes performing one or more automated actions in connection with the at least one returned inventory item based at least in part on at least a portion of the determined health-related information.

Illustrative embodiments can provide significant advantages relative to conventional refurbishment techniques. For example, problems associated with resource wastage, detrimental environmental impacts, and user dissatisfaction are overcome in one or more embodiments through automatically determining health-related information of a returned inventory item using artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for determining health-related information of returned inventory using artificial intelligence techniques in an illustrative embodiment.

FIG. 2 shows an example data flow for extracting inventory-related data in an illustrative embodiment.

FIG. 3 shows an example architecture of a multi-layer mathematical model for determining remaining useful life of an inventory item in an illustrative embodiment.

FIG. 4 is a flow diagram of a process for determining health-related information of returned inventory using artificial intelligence techniques in an illustrative embodiment.

FIGS. 5 and 6 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

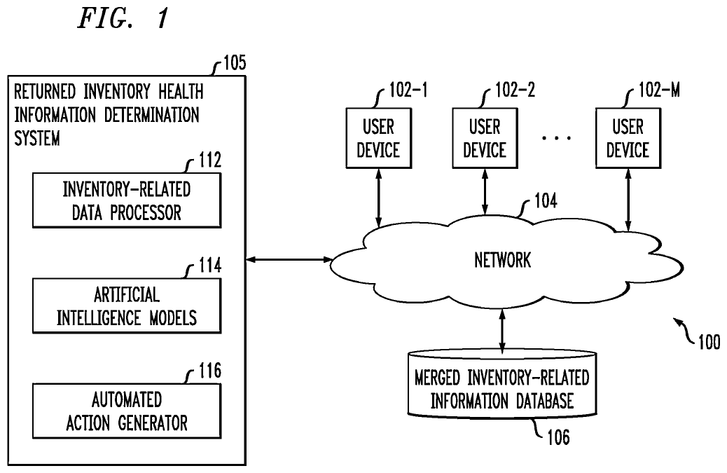

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is returned inventory health information determination system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, returned inventory health information determination system 105 can have an associated merged inventory-related information database 106 configured to store data which comprise, for example, refurbished inventory-related data, returned inventory-related data, in-use inventory-related data, etc.

The merged inventory-related information database 106 in the present embodiment is implemented using one or more storage systems associated with returned inventory health information determination system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with returned inventory health information determination system 105 are one or more input-output devices, which illustratively comprise keyboards, displays or other types of input-output devices in any combination. Such input-output devices can be used, for example, to support one or more user interfaces to returned inventory health information determination system 105, as well as to support communication between returned inventory health information determination system 105 and other related systems and devices not explicitly shown.

Additionally, returned inventory health information determination system 105 in the FIG. 1 embodiment is assumed to be implemented using at least one processing device. Each such processing device generally comprises at least one processor and an associated memory, and implements one or more functional modules for controlling certain features of returned inventory health information determination system 105.

More particularly, returned inventory health information determination system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows returned inventory health information determination system 105 to communicate over the network 104 with the user devices 102, and illustratively comprises one or more conventional transceivers.

The returned inventory health information determination system 105 further comprises inventory-related data processor 112, artificial intelligence models 114, and automated action generator 116.

It is to be appreciated that this particular arrangement of elements 112, 114 and 116 illustrated in the returned inventory health information determination system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for determining health-related information of returned inventory using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, returned inventory health information determination system 105 and merged inventory-related information database 106 can be on and/or part of the same processing platform.

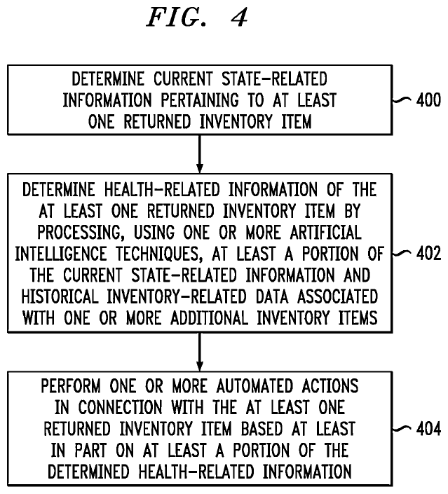

An exemplary process utilizing elements 112, 114 and 116 of an example returned inventory health information determination system 105 in computer network 100 will be described in more detail with reference to the flow diagram of FIG. 4.

Accordingly, at least one embodiment includes generating and/or implementing a framework to predict the lifespan and/or related health information of returned inventory (e.g., devices or hardware such as computers, workstations, monitors, etc.) before refurbishing, reselling, and/or abandoning the inventory. Such an embodiment can result in limiting and/or reducing the number of users who need to return or exchange refurbished inventory.

In at least one embodiment, when one or more inventory items are returned by at least one user, the one or more items are examined to obtain and/or determine current state data thereof. By way of example, because many systems are combinations of parts, before accepting a system as a return, the system can be scanned to determine and/or identify information related to the current health (e.g., any defects) of the system, using one or more patterns related to combinations of the relevant parts against historical data. Additionally, using historical data (e.g., log data) of the one or more items and/or other similar items (e.g., additional instances of the same item(s)), one or more embodiments include compiling one or more datasets to be used in identifying at least one underlying pattern in the current item(s) and/or predicting an amount of remaining useful life for the current item(s) (e.g., how long can the item(s) be used productively by a user).

As further detailed herein, if such an embodiment determines that a given item's predicted lifespan is below a predetermined threshold value, the item is not refurbished for resale (e.g., the item is disposed of). In at least one embodiment, such threshold values can be determined by the relevant enterprise and/or user, and such threshold values can be different for different systems. In contrast, if at least one embodiment determines that a given item's predicted lifespan meets or exceeds a predetermined threshold value, then such an embodiment includes refurbishing the item or portions thereof and attempting to resell the item after refurbishment (e.g., with a corresponding warranty related to the refurbishment process). By making such lifespan-related determinations, resource losses can be reduced, for example, due to the reduction of unnecessary returns of refurbished inventory items and expenditures related thereto.

In at least one embodiment, a given inventory item's telemetry information associated with the previous and/or original user can be stored, for example, in at least one user machine and mapped to at least one enterprise backend system (e.g., mapped using the service tag associated with the inventory item). Accordingly, in such an embodiment, such telemetry information can be obtained (e.g., periodically per a given schedule) and used to determine and/or predict health-related information pertaining to the given inventory item. Additionally, in one or more embodiments, user-provided information (e.g., user-stated reasons for the return of the inventory item) can also be used in making such a determination and/or prediction.

As noted and further detailed herein, telemetry data pertaining to one or more inventor items can be mapped, for example, to refurbishment data and/or other inventory-related data, using at least one inventory management tool.

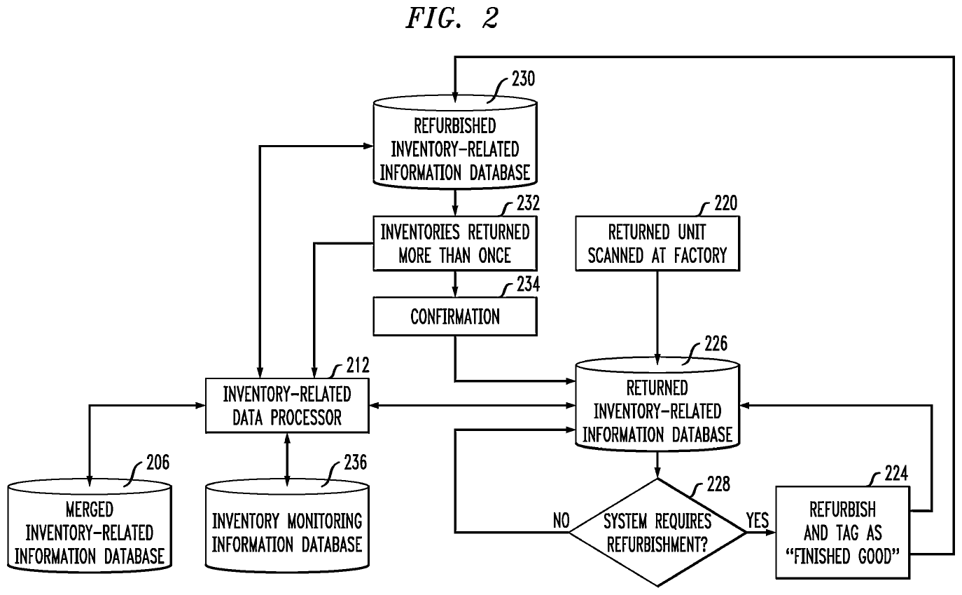

FIG. 2 shows an example data flow for extracting inventory-related data in an illustrative embodiment. By way of illustration, FIG. 2 depicts inventory-related data processor 212 processing data from multiple sources and ultimately outputting data to merged inventory-related information database 206. More specifically, data pertaining to a returned inventory unit scanned at a factory 220 is stored in returned inventory-related information database 226. Based at least in part on the information stored in returned inventory-related information database 226, a determination is made in step 228 as to whether a given system requires refurbishment. If no, then data pertaining to that determination is stored in returned inventory-related information database 226. If yes, then the given system is refurbished and tagged as a “finished good” 224, and data related thereto is provided to returned inventory-related information database 226 and refurbished inventory-related information database 230.

As also depicted in FIG. 2, based at least in part on data stored in refurbished inventory-related information database 230, inventory items returned more than once can be identified in step 232 and checked and/or confirmed in step 234 by processing returned inventory-related information database 226. Additionally, data from refurbished inventory-related information database 230 can be provided to and/or accessed by inventory-related data processor 212.

Additionally, data pertaining to the inventory items returned more than once, as determined in step 232, data from returned inventory-related information database 226, and log data and/or telemetry data from inventory monitoring information database 236 can be processed and/or merged by inventory-related data processor 212. Based at least in part on such processing and/or merging, inventory-related data processor 212 outputs and stores data in merged inventory-related information database 206.

As used herein, remaining useful life refers to a length of time that a given inventory item is likely to operate before the item requires repair or replacement. In one or more embodiments, the methodology for determining and/or predicting lifespan information such as remaining useful life for at least one inventory item includes implementing a combination of artificial intelligence models.

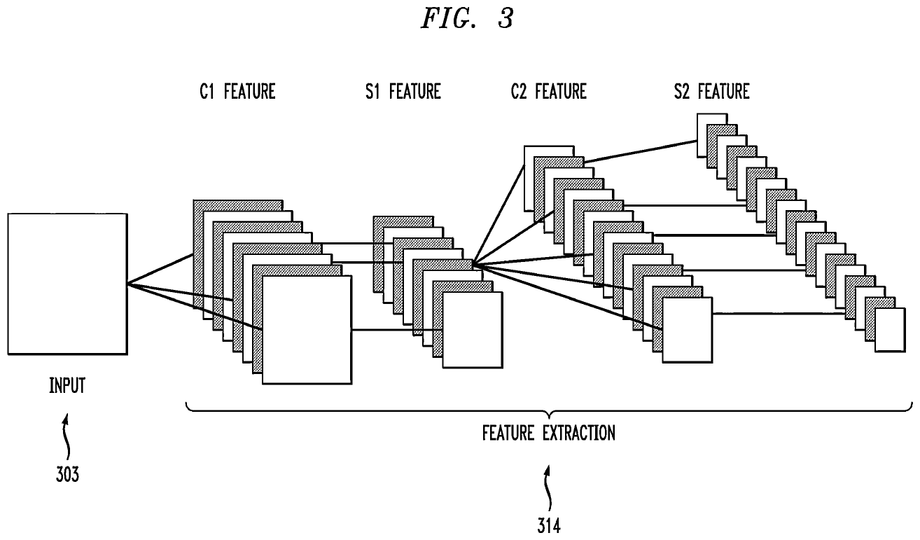

FIG. 3 shows an example architecture of a multi-layer mathematical model for determining remaining useful life of an inventory item in an illustrative embodiment. By way of illustration, FIG. 3 depicts the processing of input 303 (e.g., input data) by one or more artificial intelligence models 314, wherein such processing includes implementing one or more feature extraction techniques to determine and/or extract a C1 feature, an S1 feature, a C2 feature, and an S2 feature. In the example embodiment depicted in FIG. 3, C1, S1, C2, and S2 represent features extracted from the input 303. For example, after scanning and/or receiving log data in text format, useful information can be extracted at multiple layers. Additionally, in accordance with such an embodiment, one or more artificial intelligence models 314 can include a combination of artificial intelligence and text extraction techniques.

As also detailed above in connection with FIG. 2, input 303 can include current state data of a given inventory item and/or at least one set of merged data from multiple inventory-related data sources. For example, such data sources can include one or more inventory management tools which can process and/or store data related, for example, to inventory items subject to repeat resales. Such data sources can also include, for instance, log data created during refurbishment of returned inventory items. Further, such data sources can include telemetry data derived from monitoring in-use inventory items and/or detecting issues with in-use inventory items. In one or more embodiments, data from such varied data sources can be merged on the basis of service tags. In such an embodiment, a service tag can function as a unique identifier, which is common among different data sets.

With respect to the feature extraction techniques noted above in connection with the one or more artificial intelligence models 314, at least one embodiment can include implementing one or more degradation models in combination with one or more classification models. In such an embodiment, feature extraction includes the process of extracting useful information from logs. Further, that information can be used for a detailed time-based investigation to understand the decay rate of any system and/or part thereof. For example, a comparison can be carried out of any system against the historical data available for systems with the same configuration and indicators and/or features extracted from logs.

By way of example, such degradation models can include at least one linear degradation model and at least one exponential degradation model, which can be implemented to predict the remaining useful life of one or more inventory items. Such an embodiment can include using historical data for systems (e.g., lifespan information), as well as logs and scanned part information available as features. For an initial understanding of the pattern(s) available in the given data, at least a portion of the given data is visualized and compared against the data available for those systems for which a remaining useful life prediction is sought.

Additionally, such classification models can include, for example, at least one reliability and covariate survival model, which performs a survival probability-based binary classification to predict if an inventory item will fail within a certain time frame. At least one embodiment can include using data extracted from support-related logs, which can provide information about the state of the part(s) of the system(s) at one or more given time intervals. Processing such data using a reliability and covariate survival model can provides a probabilistic score, which can be used in connection with further decision making pertaining to the system.

Also, such classification models can include, for example, at least one time-based similarity model for multi-class classification, which predicts if an inventory item will fail in different time intervals (e.g., within 30 days, within one quarter, within six months, etc.). Such an embodiment includes performing a time-based study to understand periodic decay in the given system.

As further detailed herein, at least one embodiment includes implementing a combination of one or more regression models and one or more classification models. In such an embodiment, one or more regression models are used to predict a given inventory item's remaining useful life and a related expected time of failure. Predicting the remaining useful life of a given inventory item can include using cross-sectional data to predict the amount of time remaining before failure of the item. Such a process can involve multiple steps including, for example, feature engineering to optimize the model(s) and making one or more choices among different regression models. For instance, one or more embodiments can include selecting a model with respect to linear regression, based at least in part on the model's description and performance. Based on the study of the visualization of data and relationships corresponding thereto, such an embodiment can include selecting amongst different supervised learning regression models for prediction of remaining useful life and for classification. For example, such selections can be based at least in part on packetization of predicted remaining useful life values and/or training classification models against training data.

Additionally, as noted above, at least one embodiment includes using one or more regression models to predict an amount of time until failure of a given inventory item. Based at least in part on results from a corresponding remaining useful life determination, as well as one or more additional time-based features, such an embodiment includes determining and/or predicting the expected time of failure for the given inventory item (e.g., wherein the time is in units of days or weeks). By way merely of example, if the remaining useful life of a given system is predicted to be 36 months, then it can be expected that after 36 months, the system may fail. Using such logic, an enterprise can, for example, optimize warranty offerings associated with that system.

As also noted above, one or more embodiments include utilizing one or more classification models. Such classification models can include, for example, one or more binary classification models and one or more multi-class classification models. As used herein, binary classification refers to a process of predicting dichotomous outcomes. By way merely of illustration, at least one embodiment includes leveraging binary classification to predict if a given inventory item will fail within a certain time frame (e.g., within a given warranty period) or not.

As used herein, multi-class classification can include more granular determinations (than binary classification). For instance, an embodiment such as detailed above in connection with predicting if a given inventory item will fail within a certain time frame or not, multi-class classification can be leveraged to narrow down the prediction to at least one given time interval (e.g., within a 30 day period within the given time frame, within a particular quarter within the given time frame, within one year within the given time frame, etc.). Such a determination could facilitate, for example, making decisions pertaining to applicable services sold with any inventory item. Accordingly, multi-class classification refers to a process of assigning multiple categories, and can include, for example, a probabilistic model which assigns probabilities from one or more data features to different categories (e.g., in respective order).

As noted, for example, in connection with FIG. 2, because data can be obtained from multiple different sources (e.g., at least one refurbished inventory-related database, at least one returned inventory-related database, and at least one telemetry-related and/or log-related database), predicting the remaining useful life of a given inventory item includes importing data from at least a portion of the multiple sources (e.g., all sources), identifying one or more common patterns and/or data aspects across the different sources, and merging at least a portion of the data related to such identifications.

In one or more embodiments, processing data from multiple sources can include using one or more visualization libraries (for example, defined functions which are reusable for performing visual analysis of data (e.g., “mlplot” in Python)). In such an embodiment, using one or more visualization libraries can include analyzing data variables across the multiple sources and understanding one or more relationships among the analyzed data variables and/or one or more patterns across the analyzed data variables (e.g., FIRST_SELL_DATE, RETURN_DATE, CONFIG_ID, COUNTRY, CONDITION, SEGMENT, LOB, SERIES, FAMILY_NAME, MOTHERBOARD, PROCESSOR, MEMORY, HARD_DRIVE, etc.).

In one or more embodiments, such data variables can be derived from multiple sources. For example, log-based data can provide performance measures of different parts of a system (e.g., memory, hard disk, motherboard, etc.), and sources of such data can include the scanning of systems before accepting the systems as returned systems, as well as support-related logs, which provide data for runtime performance of systems at different time intervals. By way of further example, another source can include information related to enterprise conditions such as, e.g., if a group of a given system is in production or not. Yet another source can include availability-based information.

By way merely of illustration, such analysis can reveal, for example, that two or more data variables are sufficiently co-related such that one of the data variables can cover the variability explained by the one or more other variables. Visual comparison of data from at least one historical set of data and a new/current set of data can assist in understanding one or more existing patterns. Also, time-based visualization can assist in understanding the performance of any system, as using an incremental training dataset in accordance with an example embodiment would include covering most of the potential variations. In such an instance, one or more embodiments may include using data pertaining to only one of those data variables in the model.

In at least one embodiment, one or more models including a large number of data variables can be implemented, and therefore, such an embodiment can include determining the importance of one or more independent features which could facilitate predicting the remaining useful life of one or more inventory items. Such an embodiment can include using one or more algorithms in make such determinations, wherein such algorithms can include, for example, at least one eigenvalue-based singular value decomposition (SVD) and/or principal component analysis (PCA). SVD is a dimensionality reduction technique which can use the spectral theorem. Any real m×n matrix can be decomposed into SVD, and one or more embodiments can include decomposing an original data set A, an m×n symmetric matrix into three parts, as given in Equation (1):

A=QΣQ^{T} (1)

wherein Q represents eigenvectors of A, and includes an m×n orthogonal matrix, wherein Σ represents an eigenvalue of A, and includes an m×n diagonal matrix, and wherein Q^{T} represents an n×n orthogonal matrix.

Additionally, one or more embodiments include at least one modeling step for which at least one training set of data and at least one testing set of data are prepared and/or obtained. Because, in such an embodiment, an algorithm to be used can include a supervised model, such a modeling step can include checking the distribution of data against one or more target variables. In the case of imbalance among different target variables, at least one embodiment can include carry out one or more sampling techniques to regain and/or improve balance. Subsequently, the resulting data would be divided into one or more training dataset and one or more testing datasets (e.g., on a 20% to 80% basis, respectively).

Further, one or more embodiments can also include, during data preparation as part of the modeling process, labeling at least a portion of the data in accordance with multiple categories (e.g., temporal-based categories, lifespan-related categories, etc.). Such labeling can be used in connection with at least one training dataset.

As further detailed herein, one or more embodiments include implementing one or more similarity models in connection with determining the remaining useful life of at least one given inventory item. For example, such a model can include a hash similarity model. Because at least one embodiment can include utilizing historical data pertaining to repeatedly returned inventory items, wherein such data can include information pertaining to the performance of each of one or more components of the given inventory item as well as lifespan-related information for the given inventory item, such an embodiment therefore includes utilizing aggregate level data for the performance of each of the one or more components of the given inventory item for multiple configurations. Accordingly, using at least one hash similarity model, performance statistics for each of the one or more components of the given inventory item are hashed with at least a portion of such aggregate level performance data, and further used to identify one or more similarities against at least one new set of data. In such an embodiment, the hash similarity model serves as a means to find similarities between statistics (e.g., mean life/decay, maximum, deviation in the condition of any part, etc.) of the training model against a new set of data. Because such statistical similarity is matched for the same part in both datasets, hashing is implemented.

Additionally or alternatively, one or more embodiments including using at least one pairwise similarity model, which uses correlation techniques and dynamic time warping (DTW) techniques to calculate the distance between signals of failures using dynamic periodicity. For such distance calculations, at least one embodiment can include using Euclidean distance values. Also, in such an embodiment, dynamic periodicity can be used to align failure signals such that the sum of the Euclidean distances between their points is the smallest of the possible values. Further, in one or more embodiments, implementing at least one pairwise similarity model facilitates the comparison of the decaying pattern of a component of a given inventory item directly with historical decaying pattern(s) from similar inventory items. In such an embodiment, hashed similarities calculated as detailed above are paired between the historical dataset and a new dataset, and its grouping is carried out (e.g., time-bound statistics of the decay of parts and its comparison between a historical dataset and new dataset).

At least one embodiment can also include using at least one residual similarity model. Taking input, for example, from at least one hash similarity model and at least one pairwise similarity model, it can be necessary to distinguish among different types of inventory items. In such a scenario, at least one residual similarity model can be implemented to helps make such a distinction. Such a residual similarity model is based at least in part on one or more residual patterns and/or one or more error patterns in data. For example, once the remaining useful life of a given inventory item is predicted using least one hash similarity model and/or at least one pairwise similarity model, the difference of the predicted value(s) against one or more actual value(s) can be calculated. The magnitude of such errors designates the similarity that the test component has with a corresponding new configuration of the given inventory item. In at least one embodiment, the residual similarity includes a comparison of the predicted life expectancy of a system against the reference which is available for any given category of systems in the historical dataset as actual values.

It is to be appreciated that a “model,” as used herein, refers to an electronic digitally stored set of executable instructions and data values, associated with one another, which are capable of receiving and responding to a programmatic or other digital call, invocation, and/or request for resolution based upon specified input values, to yield one or more output values that can serve as the basis of computer-implemented recommendations, output data displays, machine control, etc. Persons of skill in the field may find it convenient to express models using mathematical equations, but that form of expression does not confine the model(s) disclosed herein to abstract concepts; instead, each model herein has a practical application in a processing device in the form of stored executable instructions and data that implement the model using the processing device.

FIG. 4 is a flow diagram of a process for determining health-related information of returned inventory using artificial intelligence techniques in an illustrative embodiment. It is to be understood that this particular process is only an example, and additional or alternative processes can be carried out in other embodiments.

In this embodiment, the process includes steps 400 through 404. These steps are assumed to be performed by the returned inventory health information determination system 105 utilizing its elements 112, 114 and 116.

Step 400 includes determining current state-related information pertaining to at least one returned inventory item. In at least one embodiment, determining the current state-related information pertaining to the at least one returned inventory item includes processing one or more of log data and telemetry data associated with the at least one returned inventory item.

Step 402 includes determining health-related information of the at least one returned inventory item by processing, using one or more artificial intelligence techniques, at least a portion of the current state-related information and historical inventory-related data associated with one or more additional inventory items. In one or more embodiments, determining health-related information of the at least one returned inventory item includes processing, using the one or more artificial intelligence techniques in conjunction with one or more visualization libraries, at least a portion of the current state-related information and historical inventory-related data associated with one or more additional inventory items. Also, in at least one embodiment, the one or more additional inventory items can include one or more inventory items of a same type to the at least one returned inventory item.

Also, in one or more embodiments, determining health-related information of the at least one returned inventory item includes predicting a remaining useful life of the at least one returned inventory item using the one or more artificial intelligence techniques. In such an embodiment, predicting the remaining useful life of the at least one returned inventory item can include using at least one of one or more regression models, one or more degradation models, one or more classification models, and one or more similarity models. The one or more degradation models can include at least one linear degradation model and at least one exponential degradation model. Also, the one or more classification models can include at least one binary classification model which predicts whether the at least one returned inventory item will fail within a given time frame, and at least one multi-class classification model which predicts whether the at least one returned inventory item will fail in different time intervals. Additionally, the one or more similarity models can include at least one hash similarity model which hashes performance statistics for each of one or more components of the at least one returned inventory item with aggregate level performance data across multiple inventory items, at least one pairwise similarity model which uses one or more correlation techniques and one or more dynamic time warping techniques to calculate distance values between signals of failure using dynamic periodicity, and at least one residual similarity model which determines one or more distinctions across outputs from the at least one hash similarity model and the at least one pairwise similarity model.

Step 404 includes performing one or more automated actions in connection with the at least one returned inventory item based at least in part on at least a portion of the determined health-related information. In at least one embodiment, performing one or more automated actions includes automatically initiating one or more operations related to refurbishing the at least one returned inventory item upon a determination that the determined health-related information includes at least one remaining useful life value above a predetermined threshold value. Alternatively, performing one or more automated actions can include automatically initiating one or more operations related to disposing of the at least one returned inventory item upon a determination that the determined health-related information includes at least one remaining useful life value below a predetermined threshold value. Further, in at least one embodiment, performing one or more automated actions includes automatically training at least a portion of the one or more artificial intelligence techniques using feedback related to the determined health-related information.

The techniques depicted in FIG. 4 can also include obtaining the historical inventory-related data associated with one or more additional inventory items from multiple data sources, wherein the multiple data sources include one or more inventory management tools which process data related to one or more inventory items subject to repeat resales, log data created during refurbishment of one or more returned inventory items, and telemetry data derived from monitoring one or more in-use inventory items. At least one embodiment can also include merging at least portions of the obtained historical inventory-related data on a basis of one or more service tags.

Accordingly, the particular processing operations and other functionality described in conjunction with the flow diagram of FIG. 4 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically determine health-related information of returned inventory using artificial intelligence techniques. These and other embodiments can effectively overcome problems associated with resource wastage, detrimental environmental impacts, and user dissatisfaction.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

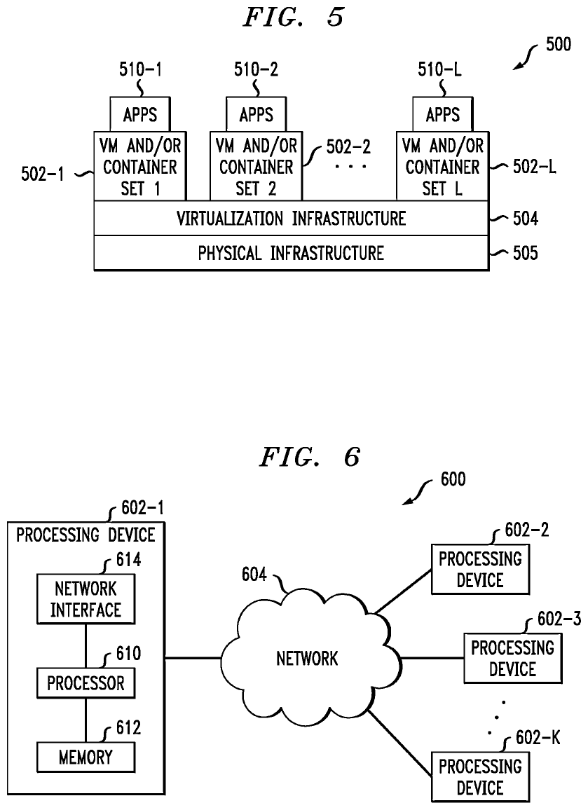

Illustrative embodiments of processing platforms will now be described in greater detail with reference to FIGS. 5 and 6. Although described in the context of system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that are utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 comprise respective VMs, respective sets of one or more containers, or respective sets of one or more containers running in VMs. In some implementations of the FIG. 5 embodiment, the VMs/container sets 502 comprise respective VMs implemented using virtualization infrastructure 504 that comprises at least one hypervisor.

A hypervisor platform may be used to implement a hypervisor within the virtualization infrastructure 504, wherein the hypervisor platform has an associated virtual infrastructure management system. The underlying physical machines comprise one or more information processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 602-1 in the processing platform 600 comprises a processor 610 coupled to a memory 612.

The processor 610 comprises a microprocessor, a CPU, a GPU, a TPU, a microcontroller, an ASIC, a FPGA or other type of processing circuitry, as well as portions or combinations of such circuitry elements.

The memory 612 comprises random access memory (RAM), read-only memory (ROM) or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
determining current state-related information pertaining to at least one returned inventory item;
determining health-related information of the at least one returned inventory item by processing, using one or more artificial intelligence techniques, at least a portion of the current state-related information and historical inventory-related data associated with one or more additional inventory items; and
performing one or more automated actions in connection with the at least one returned inventory item based at least in part on at least a portion of the determined health-related information;
wherein the method is performed by at least one processing device comprising a processor coupled to a memory.

2. The computer-implemented method of claim 1, wherein determining health-related information of the at least one returned inventory item comprises predicting a remaining useful life of the at least one returned inventory item using the one or more artificial intelligence techniques.

3. The computer-implemented method of claim 2, wherein predicting the remaining useful life of the at least one returned inventory item comprises using at least one of one or more regression models, one or more degradation models, one or more classification models, and one or more similarity models.

4. The computer-implemented method of claim 3, wherein the one or more degradation models comprise at least one linear degradation model and at least one exponential degradation model.

5. The computer-implemented method of claim 3, wherein the one or more classification models comprise:
at least one binary classification model which predicts whether the at least one returned inventory item will fail within a given time frame; and
at least one multi-class classification model which predicts whether the at least one returned inventory item will fail in different time intervals.

6. The computer-implemented method of claim 3, wherein the one or more similarity models comprise:
at least one hash similarity model which hashes performance statistics for each of one or more components of the at least one returned inventory item with aggregate level performance data across multiple inventory items;
at least one pairwise similarity model which uses one or more correlation techniques and one or more dynamic time warping techniques to calculate distance values between signals of failure using dynamic periodicity; and
at least one residual similarity model which determines one or more distinctions across outputs from the at least one hash similarity model and the at least one pairwise similarity model.

7. The computer-implemented method of claim 1, wherein performing one or more automated actions comprises automatically initiating one or more operations related to refurbishing the at least one returned inventory item upon a determination that the determined health-related information comprises at least one remaining useful life value above a predetermined threshold value.

8. The computer-implemented method of claim 1, wherein performing one or more automated actions comprises automatically initiating one or more operations related to disposing of the at least one returned inventory item upon a determination that the determined health-related information comprises at least one remaining useful life value below a predetermined threshold value.

9. The computer-implemented method of claim 1, wherein performing one or more automated actions comprises automatically training at least a portion of the one or more artificial intelligence techniques using feedback related to the determined health-related information.

10. The computer-implemented method of claim 1, further comprising:
obtaining the historical inventory-related data associated with one or more additional inventory items from multiple data sources, wherein the multiple data sources comprise one or more inventory management tools which process data related to one or more inventory items subject to repeat resales, log data created during refurbishment of one or more returned inventory items, and telemetry data derived from monitoring one or more in-use inventory items.

11. The computer-implemented method of claim 10, further comprising:
merging at least portions of the obtained historical inventory-related data on a basis of one or more service tags.

12. The computer-implemented method of claim 1, wherein determining health-related information of the at least one returned inventory item comprises processing, using the one or more artificial intelligence techniques in conjunction with one or more visualization libraries, at least a portion of the current state-related information and historical inventory-related data associated with one or more additional inventory items.

13. The computer-implemented method of claim 1, wherein determining the current state-related information pertaining to the at least one returned inventory item comprises processing one or more of log data and telemetry data associated with the at least one returned inventory item.

14. The computer-implemented method of claim 1, wherein the one or more additional inventory items comprise one or more inventory items of a same type to the at least one returned inventory item.

15. A non-transitory processor-readable storage medium having stored therein program code of one or more software programs, wherein the program code when executed by at least one processing device causes the at least one processing device:
to determine current state-related information pertaining to at least one returned inventory item;
to determine health-related information of the at least one returned inventory item by processing, using one or more artificial intelligence techniques, at least a portion of the current state-related information and historical inventory-related data associated with one or more additional inventory items; and
to perform one or more automated actions in connection with the at least one returned inventory item based at least in part on at least a portion of the determined health-related information.

16. The non-transitory processor-readable storage medium of claim 15, wherein determining health-related information of the at least one returned inventory item comprises predicting a remaining useful life of the at least one returned inventory item using the one or more artificial intelligence techniques.

17. The non-transitory processor-readable storage medium of claim 15, wherein performing one or more automated actions comprises automatically initiating one or more operations related to refurbishing the at least one returned inventory item upon a determination that the determined health-related information comprises at least one remaining useful life value above a predetermined threshold value.

18. An apparatus comprising:
at least one processing device comprising a processor coupled to a memory;
the at least one processing device being configured:
to determine current state-related information pertaining to at least one returned inventory item;
to determine health-related information of the at least one returned inventory item by processing, using one or more artificial intelligence techniques, at least a portion of the current state-related information and historical inventory-related data associated with one or more additional inventory items; and
to perform one or more automated actions in connection with the at least one returned inventory item based at least in part on at least a portion of the determined health-related information.

19. The apparatus of claim 18, wherein determining health-related information of the at least one returned inventory item comprises predicting a remaining useful life of the at least one returned inventory item using the one or more artificial intelligence techniques.

20. The apparatus of claim 18, wherein performing one or more automated actions comprises automatically initiating one or more operations related to refurbishing the at least one returned inventory item upon a determination that the determined health-related information comprises at least one remaining useful life value above a predetermined threshold value.
